(19) United States
(12) Patent Application Publication
(10) Pub. No.: US 2015/0032553 A1
(43) Pub. Date: Jan. 29, 2015

(54) NOVEL MARKETING, PROMOTION & DISTRIBUTION SYSTEM UTILIZING WEB-ENABLED INTERACTIVE DEVICES

(71) Applicants: Jonathan Thaler, New York, NY (US); David Friedson, New York, NY (US)

(72) Inventors: Jonathan Thaler, New York, NY (US); David Friedson, New York, NY (US)

(21) Appl. No.: 14/321,439

(22) Filed: Jul. 1, 2014

Related U.S. Application Data
(60) Provisional application No. 61/841,553, filed on Jul. 1, 2013.

(51) Int. Cl. G06Q 30/02; G06Q 20/10; G06F 3/0484; H04L 29/08; H04L 29/06

(52) U.S. Cl. CPC G06Q 30/0277; H04L 67/02; H04L 67/42; H04L 67/10; G06F 3/04842; G06Q 20/10
USPC 705/14.73

(57) ABSTRACT

The present invention is a novel marketing, promotion and distribution system utilizing Web-enabled interactive devices. The invention contemplates a client creating media content that is designed to appeal to users who are equipped with such Web-enabled devices. This content is presented in a user visual experience that, in turn, has been designed to induce an impulsive-type desire to purchase in users. The user visual experience will include multi-dimensional media which includes a portion thereof designated a visual media tag area capable of providing a visual tag including a multi-character code capable of being seen by the user who is viewing the multi-dimensional visual media. The said media content is located on a client Web server. The user enters the multi-character code on the Web-enabled device, which communicates with the client Web server using one or more of a native app, or a phone app, or a text message app. This communication establishes a real time interactive linking of the user's device to the client Web server, thereby providing real time interactive access to a client Web app on the client Web server. This enables the user to place an order for a product or service. The user product or service request is responded to via the client Web app, such as the acceptance of the user's product or service purchase order. Interactive real time payment for the product or service is enabled. A feature of the present invention includes the integration of a visual tag and the web app content and a payment system into a single system, for the benefit of the client and users. Another feature of this invention includes the ability to facilitate real time linking of the visual tag with real time coordinated mobile Web app content, in synch with the content on the tagged surface/product. Yet a further feature includes the ability of content-providing clients to create within their organizations departments whose responsibilities will include providing the best and most integrated/content-synchronized Web apps to surface/product content, including multimedia, purchase point, content information, and social links, to name but a few. It is contemplated according to the present invention that the owner of the intellectual property associated with the present invention will receive a reasonable royalty equal to a percentage of net sales of the products and services purchased.

This application claims the benefit of priority pursuant to 35 U.S.C. 119(e) from U.S. provisional patent application having Application No. 61/841,553 filed Jul. 1, 2013.

### BACKGROUND OF THE INVENTION

1. Introduction

The present invention relates generally to Web-based systems, and more particularly to a novel business method, incorporating a marketing, promotion and distribution system utilizing Web-enabled interactive devices. It is contemplated that the system according to the present invention will be used by, among others, individuals who are equipped with what have come to be called “smartphones”, tablets and other Web-enabled devices capable of obtaining access to Web apps available on the Internet. The present invention has the potential to revolutionize the manner in which individuals and providers of Web apps are able to interact with users of such devices who wish to interact with the Web apps in order to consummate commercial sales, as will be appreciated from the description below. It is contemplated according to the present invention that the owner of the intellectual property associated with the present invention will receive a reasonable royalty equal to a percentage of net sales of the products and services purchased.

2. Prior Art

Prior patent art indicates that systems are known that are device based telecommunications initiated, such as those that provide data fulfillment. An example of such a system is disclosed in U.S. Pat. No. 8,260,267 granted on Sep. 4, 2012 and assigned of record to Zoove Corp. of Palo Alto, Calif. This patent discloses a system which incorporates a preprogrammed communication device which recognizes special multi-function code digit sequences to cause service invocation. Cited and mentioned in said '267 patent is U.S. Pat. No. 5,898,917 granted on Apr. 27, 1999 and assigned of record to AG Communication Systems of Phoenix, Ariz. This '917 patent discloses the ability to provide enhanced services which are accessed from an enhanced services network element of a cellular radio telecommunications system, using a cellular carrier specific code (#CCSC) string based office-level trigger, taking advantage of #CCSC standard. When a call in the '917 system is received by the MSC in which the digits dialed start with a “#” followed by a digit sequence dialed, the MSC suspends call processing and a service query message is generated and sent to the SCP of the requested enhanced service, whereupon the SCP then sends a response message back to the MSC, which resumes call processing in accordance with the response from the SCP.

Another example of prior patent art which discloses a method of providing information to a telephony subscriber can be found in U.S. Pat. No. 7,813,716 granted on Oct. 12, 2010 and assigned of record to Single Touch Interactive, Inc. of Encinitas, Calif. This '716 patent discloses an information fulfillment system and method for providing information to a caller having a wireless communication device. Upon receipt of a sensory prompting and manual or automatic input of access codes to the wireless device, the caller's identity and the input access code are verified, whereupon the call is connected to the system messaging or fulfillment center for automatic or live-operator delivery of the requested information. Automatic verification, connection, and billing modification processes are provided as part of the implementation of this system and method.

While the aforementioned prior art are interesting and, in the case of Single Touch and Zoove, are the subject of patent infringement litigation pending in the California federal courts as of this writing, there is a need for an improved device based interactive system which is capable of providing in real time the marketing, promotion and distribution of products and services, utilizing a business method such as that provided by the present invention.

### SUMMARY OF THE INVENTION

The present invention contemplates a novel marketing, promotion and distribution system which utilizes Web-enabled interactive devices for the sale of products and services. The invention further contemplates using this system for inducing and obtaining contributions to not for profit organizations such as, without limitation, public broadcasting services, and the like.

The invention contemplates what will herein be designated as a client creating, alone or with others, media content that is designed to appeal to users who are equipped with such Web-enabled devices. This content, which may be static or dynamic, is presented in a user visual experience that, in turn, has been designed to induce an anticipated and hoped-for reaction, such as an impulsive-type desire to purchase, in users. The user visual experience will comprise at least in part multi-dimensional media which includes a portion thereof designated a visual media tag area. A visual tag is provided within the visual media tag area which preferably includes a multi-character code capable of being seen by the user who is viewing the multi-dimensional visual media. Thus, the tag is integrated into the screen or visible real estate of the content media. The said media content is located on a client Web server. Upon the user's having a reaction to said media content, the user enters the multi-character code on his or her Web-enabled device, which communicates it using one or more of a native app, or a phone app, or a text message app. This transmission communication establishes a real time interactive linking of the user's device to the client Web server, thereby providing the user with real time interactive access to a client Web app on the client Web server. This enables the user to provide a user order request for a product or service from the user Web-enabled device to the Web server. The real time interactive linking further enables the user request to be responded to via the client Web app, such as the acceptance of the user's product or service purchase order. The interactive real time linking further provides an opportunity for real time payment by the user (by PayPal or alternative service, for example) for the product or service, thereby facilitating the consummation of a commercial sale by this business method.

Significantly, by the user interacting with the client Web app, the user may be identified to the client and/or a party authorized by the client by his or her email address or cellphone number. The optional lawful use of this information is contemplated.

By way of example, and without in any way limiting the scope of the present invention, a producer of a television movie having cartoon characters will tailor the movie content to include on the television screen a visual tag area at the lower right portion of the visual content media. A visual tag containing multiple characters, including a unique code, is projected within this visual tag area. The code may be modified from time to time, as will be appreciated from this discussion. A user who is equipped with a Web-enabled device such as an iPhone, for example, will see the visual tag and will enter the multiple character including the code into the device. This will in real time interactively link the user to the movie producer's Web app on the producer's Web server, whereupon the user will see advertisements for branded products incorporating the cartoon characters in the movie. The user is able to immediately, in real time, place an order for such products, all of this occurring within a matter of minutes.

A feature of the present invention includes the integration of a visual tag and the web app content and a payment system into a single system, for the benefit of the client and users. Another feature of this invention includes the ability to facilitate real time linking of the visual tag with real time coordinated mobile Web app content, in synch with the content on the tagged surface/product. Yet a further feature includes the ability of content-providing clients to create within their organizations departments whose responsibilities will include providing the best and most integrated/content-synchronized Web apps to surface/product content, including multimedia, purchase point, content information, and social links, to name but a few. It is contemplated according to the present invention that the owner of the intellectual property associated with the present invention will receive a reasonable royalty equal to a percentage of net sales of the products and services purchased.

BRIEF DESCRIPTION OF THE DRAWINGS/FIGURES

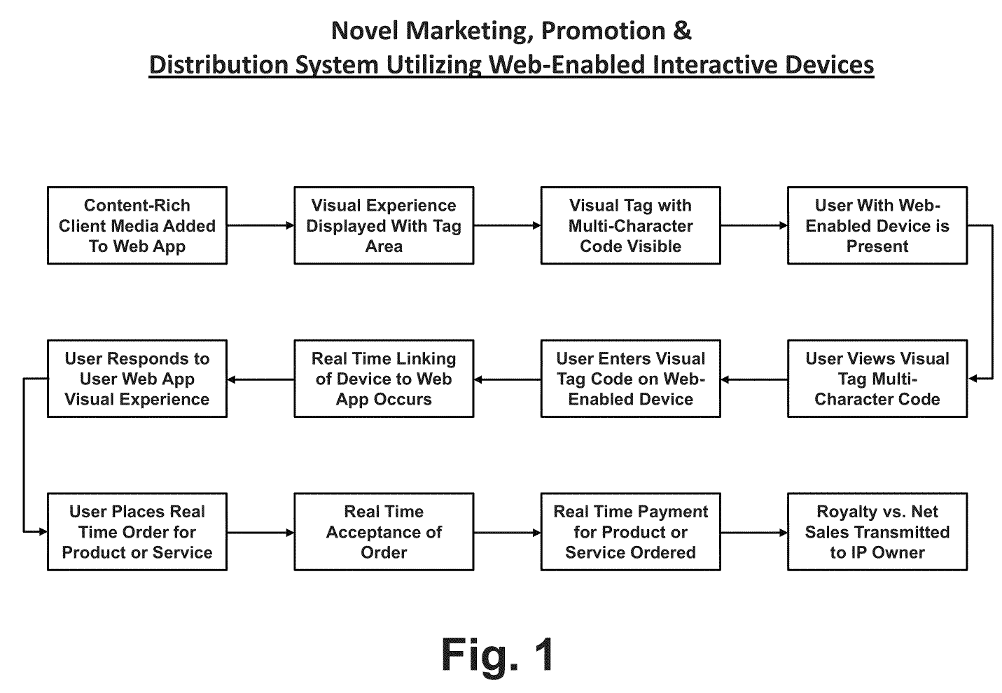

FIG. 1 is a schematic block diagram multi-step flow diagram in which method steps according to the present invention are illustrated in sequential order, according to one embodiment of the present invention;

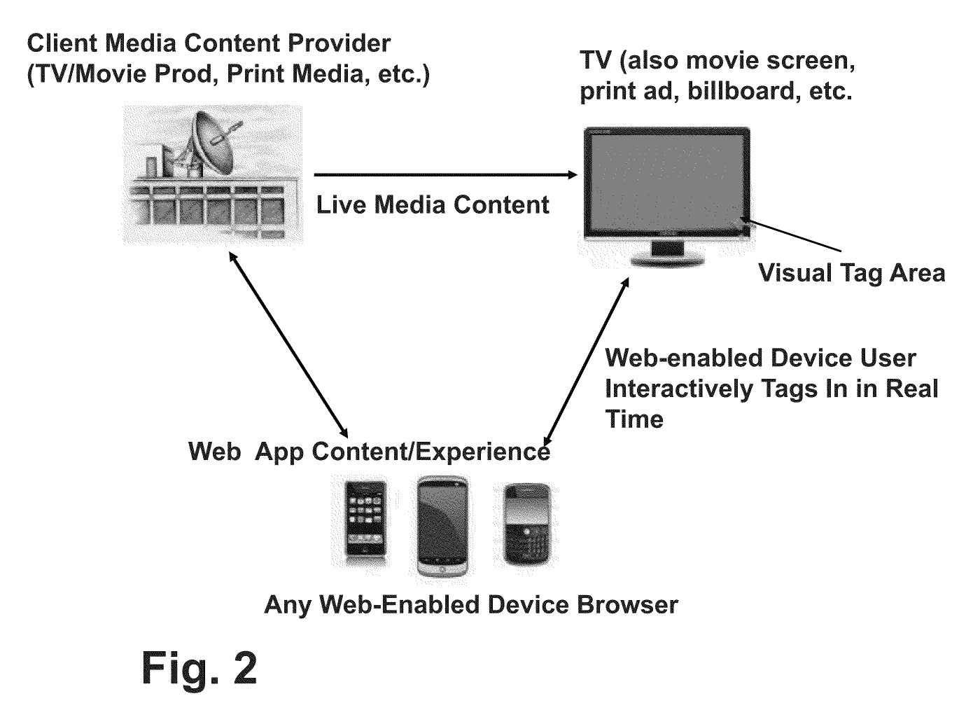

FIG. 2 is a schematic illustration of elements of the system according to the present invention, wherein a client content provider, a television screen and typical Web-enabled devices are illustrated in interactive relationship with one another; and

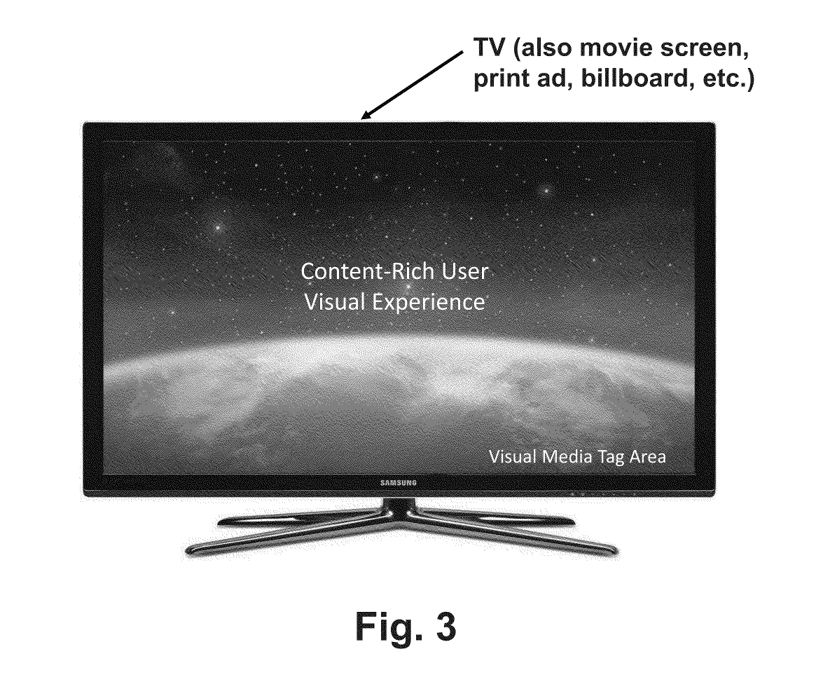

FIG. 3 is an illustration of a TV or alternative media delivery system which will display to users a content-rich user visual experience, and further illustrating in a lower right hand portion thereof an optional location of a visual media tag area.

### DETAILED DESCRIPTION OF THE INVENTION

This invention contemplates what will herein be designated as a client creating, alone or with others, media content that will appeal to users who are equipped with Web-enabled devices. By way of example only, this content is presented on a movie screen, a television screen, in a magazine print ad, on a billboard, or any other visual media visible to users. The media content will comprise a user visual experience in users that has been designed to induce an anticipated and hoped-for reaction, such as an impulsive-type desire to purchase a product or service. The user visual experience will comprise at least in part multi-dimensional media which includes a portion thereof designated a visual media tag area. A visual tag is provided within the visual media tag area which preferably includes a multi-character code capable of being seen by the user who is viewing the multi-dimensional visual media. The said media content is located on a client Web server. Upon the user's having a reaction to said media content, the user enters the multi-character code on his or her Web-enabled device, which communicates it using one or more of a native app, or a phone app, or a text message app. This transmission communication establishes a real time interactive linking of the user's device to the client Web server, thereby providing the user with real time interactive access to a client Web app on the client Web server. This enables the user to provide a user order request for a product or service from the user Web-enabled device to the Web server. The real time interactive linking further enables the user request to be responded to via the client Web app, such as the acceptance of the user's product or service purchase order. The interactive real time linking further provides an opportunity for real time payment by the user for the product or service, thereby facilitating the consummation of a commercial sale by this business method.

FIG. 1 illustrates in a schematic block flow diagram steps in the business method of the present invention. The flow is in the direction of the arrows shown.

FIG. 2 provides a pictorial representation of smartphones, a TV screen, and the transmission of client media content by a media content provider.

FIG. 3 simply shows in an enlarged schematic a TV screen on which a content-rich user visual experience will be projected and visible to users. The TV screen includes a visual media tag area in which the coded tag will appear, so that the user will be able to copy the code onto his or her Web-enabled device.

By way of example, and at the risk of repetition, without in any way limiting the scope of the present invention, a producer of a television movie having cartoon characters will tailor the movie content to include on the television screen a visual tag area at the lower right portion of the visual content media. A visual tag containing multiple characters, including a unique code, is projected within this visual tag area. The code may be modified from time to time, as will be appreciated from this discussion. A user who is equipped with a Web-enabled device such as an iPhone, for example, will see the visual tag and will enter the multiple character including the code into the device. This will in real time interactively link the user to the movie producer's Web app on the producer's Web server, whereupon the user will see advertisements for branded products incorporating the cartoon characters in the movie. The user is able to immediately, in real time, place an order for such products, all of this occurring within a matter of minutes.

A feature of the present invention includes the integration of a visual tag and the web app content and a payment system into a single system, for the benefit of the client and users. Another feature of this invention includes the ability to facilitate real time linking of the visual tag with real time coordinated mobile Web app content, in synch with the content on the tagged surface/product. Yet a further feature includes the ability of content-providing clients to create within their organizations departments whose responsibilities will include providing the best and most integrated/content-synchronized Web apps to surface/product content, including multimedia, purchase point, content information, and social links, to name but a few. It is contemplated according to the present invention that the owner of the intellectual property associated with the present invention will receive a reasonable royalty equal to a percentage of net sales of the products and services purchased.

The present invention contemplates variations and other embodiments coming within the spirit and scope of our invention, and it is not to be improperly or unduly limited.

The following invention is claimed:

1. A business method of providing a novel interactive marketing, promotion and distribution system utilizing Web-enabled devices, comprising, in combination, the steps of:
establishing client media content designed to appeal to users who are equipped with a smartphone or other Web-enabled communication device, said content designed to be presented in a user visual experience which will induce an anticipated user reaction,
said user visual experience including multi-dimensional visual media having a visual media tag area,
providing a visual tag within the visual media tag area, said visual tag including a multi-character code visible to a user who is viewing said multi-dimensional visual media,
locating said media content on a client Web server,
enabling a reaction from the user upon the user's viewing said media content, said reaction including using said Web-enabled communication device to accept and communicate the entry of said multi-character code,
establishing a real time interactive linking of the user's device to said server via a pre-programmed built-in device browser app, said linking being enabled through one or more of (a) a phone app, or (b) a text app, or (c) a native app,
said real time interactive linking providing the user with access to a client Web app on said client Web server, thereby enabling a user order request for a product or service from said user device to the client Web server, said order request including an offer of remuneration for the purchase of a product or service,
said real time interactive linking further enabling a response to said request from said client Web server to said user device, said response including an acceptance of said offer,
said real time interactive linking yet further enabling real time payment by said user for said product or service, and
said real time interactive linking thereby facilitating the consummation of a commercial sale.
